(19) United States
(12) Patent Application Publication
(10) Pub. No.: US 2021/0286952 A1
(43) Pub. Date: Sep. 16, 2021

(54) CONVERSATION ANALYSIS SYSTEM, CONVERSATION ANALYSIS METHOD, AND CONVERSATION ANALYSIS PROGRAM

(71) Applicants: KABUSHIKI KAISHA TOSHIBA, Tokyo (JP); Toshiba Digital Solutions Corporation, Kawasaki-shi (JP)

(72) Inventors: Koichi KAGAWA, Niiza (JP); Junta ASANO, Fuchu (JP); Atsushi KAKEMURA, Kokubunji (JP); Masaharu DOI, Hachioji (JP)

(73) Assignees: KABUSHIKI KAISHA TOSHIBA, Tokyo (JP); Toshiba Digital Solutions Corporation, Kawasaki-shi (JP)

(21) Appl. No.: 17/337,611

(22) Filed: Jun. 3, 2021

Related U.S. Application Data
(63) Continuation of application No. PCT/JP2019/047481, filed on Dec. 4, 2019.

(30) Foreign Application Priority Data
Dec. 5, 2018 (JP) 2018-227965

(51) Int. Cl. G06F 40/30; H04L 29/08

(52) U.S. Cl. CPC G06F 40/30; H04L 67/10

(57) ABSTRACT

A conversation analysis system according to the present embodiment utilizes a computer and includes an input unit, a conversation analysis model unit and an information processing unit. The input unit inputs conversational data of utterers who execute a work in cooperation. The conversation analysis model unit analyzes contents of conversations related to work cooperation made by a plurality of utterers based on the conversational data input by the input unit, using a conversation analysis model created by machine learning. The information processing unit creates a plurality of types of evaluation information related to work cooperation based on a conversation analysis result obtained by the conversation analysis model unit.

### CROSS-REFERENCE TO RELATED APPLICATION

This application is a continuation Application of PCT Application No. PCT/JP2019/047481, filed Dec. 4, 2019 and based upon and claiming the benefit of priority from Japanese Patent Application No. 2018-227965, filed Dec. 5, 2018, the entire contents of all of which are incorporated herein by reference.

### FIELD

An embodiment of the present invention relates to a conversation analysis system, a conversation analysis method, and a conversation analysis program, which are realized through the utilization of, for example, cloud computing.

### BACKGROUND

In recent years, a mechanism (cloud services such as SaaS and PaaS) capable of providing, as services, software functions and platform functions (collectively referred to as “information processing functions”) through the utilization of cloud computing has been realized.

Through an information processing function provided by such services, it has become possible to construct a system that supports the operation of, for example, certain locations in the food industry, hotels, etc., through the utilization of what is known as an artificial intelligence (AT) function.

### CITATION LIST

### Patent Literature

Patent Literature 1: Japanese Patent No. 5285575

### SUMMARY

If a system that allows for analysis of conversations among employees related to work cooperation can be constructed through the utilization of an information processing function including an AI function provided as a service, such a system will be effective as one that supports, for example, the operation of locations, etc.

Thus, the objective is to provide a conversation analysis system that allows for analysis of conversations among the employees related to work cooperation.

A conversation analysis system according to the present embodiment utilizes a computer and includes an input unit, a conversation analysis model unit and an information processing unit. The input unit inputs conversational data of utterers who execute a work in cooperation. The conversation analysis model unit analyzes contents of conversations related to work cooperation made by a plurality of utterers based on the conversational data input by the input unit, using a conversation analysis model created by machine learning. The information processing unit creates a plurality of types of evaluation information related to work cooperation based on a conversation analysis result obtained by the conversation analysis model unit.

### BRIEF DESCRIPTION OF THE DRAWINGS

FIG. 1 is a block diagram showing a configuration of a system according to an embodiment.

FIG. 2 is a flowchart for illustrating an operation of a conversation analysis processing unit according to the embodiment.

FIG. 3 is a diagram showing an example of incidental information of conversational data according to the embodiment.

FIG. 4 is a flowchart for illustrating an operation of a conversation analysis model processing unit according to the embodiment.

FIG. 5 is a conceptual diagram for illustrating a function of the conversation analysis model processing unit according to the embodiment.

FIG. 6 is a diagram for illustrating an example of a classification model based on conversation analysis according to the embodiment.

FIG. 7 is a diagram for illustrating an example of a conversation analysis result according to the embodiment.

FIG. 8 is a diagram for illustrating an example of a conversation analysis result according to the embodiment.

FIG. 9 is a diagram for illustrating a first specific example of a dashboard according to the embodiment.

FIG. 10 is a diagram for illustrating a second specific example of the dashboard according to the embodiment.

FIG. 11 is a diagram for illustrating a third specific example of the dashboard according to the embodiment.

FIG. 12 is a diagram for illustrating a fourth specific example of the dashboard according to the embodiment.

FIG. 13 is a diagram for illustrating a fifth specific example of the dashboard according to the embodiment.

FIG. 14 is a diagram for illustrating a sixth specific example of the dashboard according to the embodiment.

FIG. 15 is a diagram for illustrating a seventh specific example of the dashboard according to the embodiment.

FIG. 16 is a diagram for illustrating an eighth specific example of the dashboard according to the embodiment.

FIG. 17 is a diagram for illustrating a ninth specific example of the dashboard according to the embodiment.

FIG. 18 is a diagram showing an example of incidental information of conversational data according to a modification.

FIG. 19 is a diagram for illustrating a specific example of a dashboard according to the modification.

### DETAILED DESCRIPTION

Hereinafter, an embodiment will be described with reference to the drawings.

[Configuration of System]

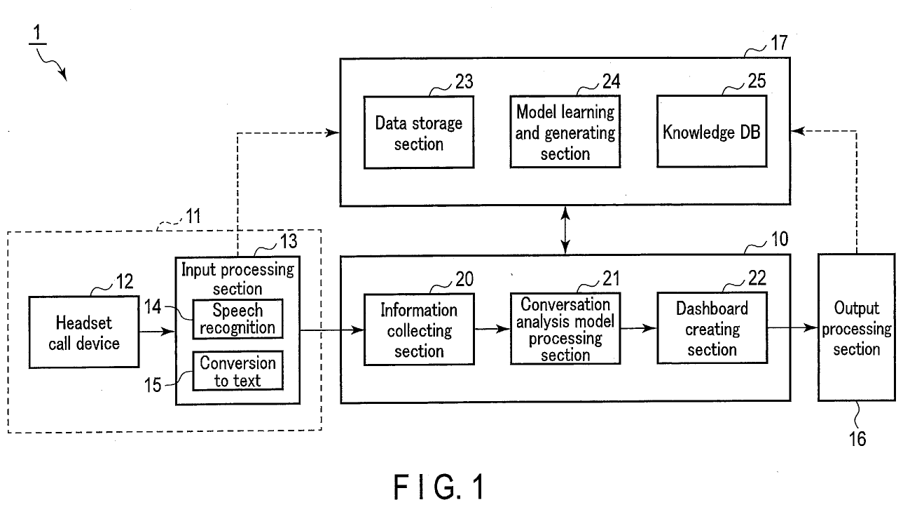

FIG. 1 is a block showing a configuration of a system 1 according to the present embodiment. As shown in FIG. 1, the system 1 is configured to include a conversation analysis processing unit 10, a speech input processing unit 11, an output processing section 16, and a server system 17. That is, the system 1 of the present embodiment is configured to include a conversation analysis system including a conversation analysis processing unit 10, a speech input processing unit 11, and an output processing section 16, and a server system 17.

The speech input processing unit 11 corresponds to a headset speech system that includes a headset call device 12 and an input processing section 13. The headset call device 12 is a type of wireless, intercommunication-type internal telephone, and is a business call device consisting of an earphone and a microphone.

The input processing section 13 includes a speech recognition section 14 and a convert-to-text section 15 that recognizes a speech signal input from the headset call device 12. The convert-to-text section 15 converts a result of speech recognition performed by the speech recognition section 14 into text data (hereinafter referred to as “conversational data”). The conversational data processed by the input processing section 13 can be displayed on a display of a terminal device such as a tablet or a smartphone (not illustrated).

The conversation analysis processing unit 10 is the main part of the conversation analysis system, and includes an information collecting section 20, a conversation analysis model processing section 21, and a dashboard creating section 22. The conversation analysis processing unit 10 is implemented on the client side through the information processing function provided as a service by the cloud server system 17, as will be described later. The client side is, for example, a personal computer (PC) which configures the above-mentioned conversation analysis system.

The information collecting section 20 collects and processes conversational data input from the input processing section 13, and outputs information on the target of conversation analysis to the conversation analysis model processing section 21. The information output from the information collecting section 20 includes information such as an utterer ID, a number of utterances, an utterance timing (including date and time, etc.), location information, a speech recognition rate, etc., as well as conversational data (text data) indicating contents of conversations.

The conversation analysis model processing section 21 analyzes the information (conversational data) output from the information collecting section 20 based on a conversation analysis model, trained by machine learning, included in the information processing function provided by the server system 17. The conversation analysis model processing section 21 outputs a conversation analysis result related to work cooperation among a plurality of utterers based on a predetermined classification model, as will be described later. Specifically, the conversation analysis result includes an analysis result obtained by analyzing the smoothness of communications among the utterers. Specific examples of the utterers include team leaders and staff members included among the employees of certain locations, hotels, etc., as will be described later.

The dashboard creating section 22 creates a dashboard related to work cooperation among a plurality of utterers (employees etc.) based on the analysis result from the conversation analysis model processing section 21. The dashboard corresponds to a plurality of types of evaluation information related to the work cooperation, and is information that can be displayed on a screen of a display device such as a smartphone or a PC, etc.

The output processing section 16 displays a dashboard created by the dashboard creating section 22 on a screen of a display device of a smartphone or a PC, etc. The output processing section 16 may be configured to transfer the dashboard to the server system 17 via the Internet.

The server system 17 provides, to the client side (PC) as a service, an information processing function that realizes the conversation analysis processing unit 10 through the utilization of cloud computing. The server system 17 includes a data storage section 23, a model learning and generating section 24, and a knowledge database (knowledge DB) 25.

The data storage section 23 stores the industry and work data related to a location as a target of analysis, in addition to the above-mentioned dashboard and the conversational data from the input processing section 13. The industry and work data contains data related to various industries and companies in general. The model learning and generating section 24 implements machine learning based on what is known as an “AI function”, and creates a conversation analysis model for the conversation analysis model processing section 21. The model learning and generating section 24 can update the conversation analysis model by repeating machine learning, if necessary, using the data stored in the data storage section 23. The knowledge DB 25 stores the conversation analysis model created by the model learning and generating section 24 and the data stored in data storage section 23 as a knowledge base.

[Advantageous Effects of System]

The conversation analysis system of the present embodiment is realized as, for example, a system that supports the operation of certain locations in the food industry, accommodation facilities (hotels), etc., on a client-side PC through the information processing function provided as a service by the cloud server system 17.

Specifically, the conversation analysis system of the present embodiment implements an information processing function that allows for analysis of conversations among employees engaged in work at certain locations, accommodation facilities, etc. related to work cooperation, and creates a dashboard for (visualizes) the analysis result. The employees include team leaders who manage the work in question and staff members who carry out the type of work.

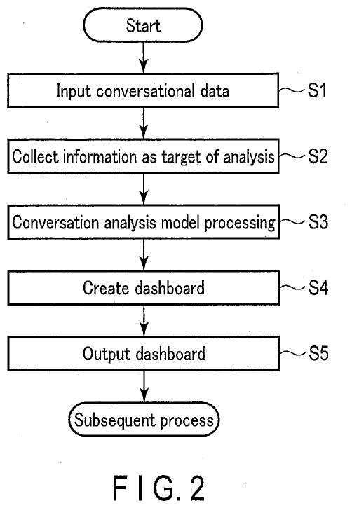

FIG. 2 is a flowchart for illustrating the operation of the conversation analysis processing unit 10, which forms the main part of the conversation analysis system of the present embodiment. As mentioned above, the conversation analysis system includes the conversation analysis processing unit 10, the speech input processing unit 11, and the output processing section 16.

As shown in FIG. 2, the conversation analysis processing unit 10 inputs conversational data from the speech input processing unit 11 (S1). Upon performing a mutual call related to work cooperation through the headset call device 12 worn by each employee, the speech input processing unit 11 inputs the contents of the mutual call. The speech input processing unit 11 causes the input processing section 13 to convert a speech recognition result of the mutual call into text data.

The information collecting section 20 collects and processes information on the conversation analysis target based on conversational data input from the speech input processing unit 11, and outputs the information to the conversation analysis model processing section 21 (S2). The information collecting section 20 outputs not only conversational data (text data) indicating contents of conversations between the employees but also information containing an utterer ID, a number of utterances, an utterance timing (including date and time, etc.), location information, and a speech recognition rate, etc. to the conversation analysis model processing section 21.

The incidental information to the conversational data output to the conversation analysis model processing section 21, such as the utterer ID, can be acquired or created by, for example, the input processing section 13. The utterer ID can be acquired by associating the user with the headset call device 12 worn by the employee. The number of utterances can be acquired by counting utterance inputs from the headset call device 12, and the location information can be obtained from the headset call device 12 equipped with the GPS. The utterance timing can be acquired from time information at the point in time when an utterance input has been made from the headset call device 12. In the case of the headset communication device 12 equipped with a clock function, time information can be acquired from the headset communication device 12. The speech recognition rate can be calculated from a recognition result obtained by the speech recognition section 14.

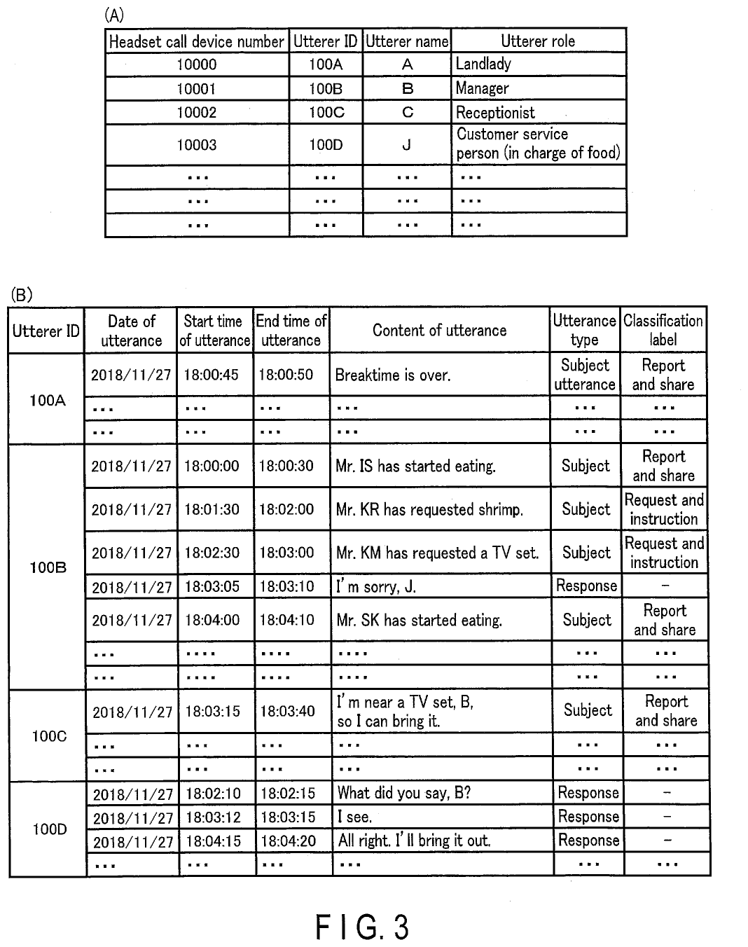

FIGS. 3(A) and 3(B) show an example of incidental information to conversational data output to the conversation analysis model processing section 21, such as the utterance ID. These items of information are stored in, for example, the data storage section 23.

As shown in FIG. 3(A), the incidental information records information indicating the device number of the headset call device 12, the utterer ID for identifying the utterer who makes an utterance from the headset call device 12, the utterer name, and the role of the utterer.

As shown in FIG. 3(B), the utterance information input from the headset call device 12 records the utterance date, the utterance start time, the utterance end time, and the utterance content, in association with the utterer ID. In the present embodiment, the utterance information is managed according to the utterer ID; however, the management method is not limited thereto, and may be managed according to the utterance date, or according to the utterance ID and the utterance date. The number of utterances may be calculated on a case-by-case basis from information collected as an analysis target; however, it is preferable that the number of utterances calculated for each utterer ID during an utterance date or a predetermined period (e.g., one week, one month, etc.) be recorded in addition to the information shown in FIG. 3(B). It is also preferable that the position information and the speech recognition rate be recorded in the data storage section 23 at the point in time when such information has been acquired from the speech input processing unit 11 in association with each utterance shown in FIG. 3(B).

The conversation analysis model processing section 21 analyzes conversational data indicating contents of conversations output from the information collecting section 20, based on the conversation analysis model trained by machine learning included in the information processing function provided by the server system 17 (S3). Specifically, the conversation analysis model processing section 21 outputs a conversation analysis result related to work cooperation among a plurality of utterers based on a predetermined classification model, as will be described later. Specifically, the conversation analysis result includes an analysis result obtained by analyzing the smoothness of communications among the utterers.

The dashboard creating section 22 creates a dashboard related to work cooperation among a plurality of utterers (employees etc.) based on the conversation analysis result from the conversation analysis model processing section 21 (S4). The dashboard corresponds to a plurality of types of evaluation information related to work cooperation among a plurality of utterers (employees, etc.). The output processing section 16 displays a dashboard created by the dashboard creating section 22 on a screen of a display device of a PC (S5).

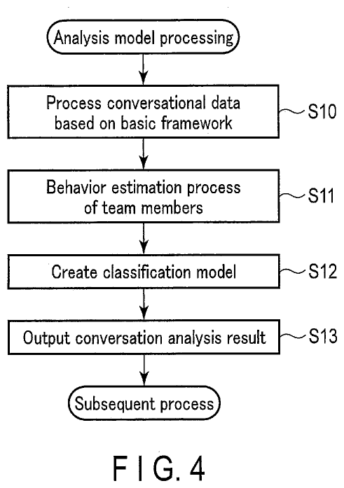

Next, the processing of the conversation analysis model processing section 21 will be described with reference to the flowchart of FIG. 4 and FIGS. 5 to 8.

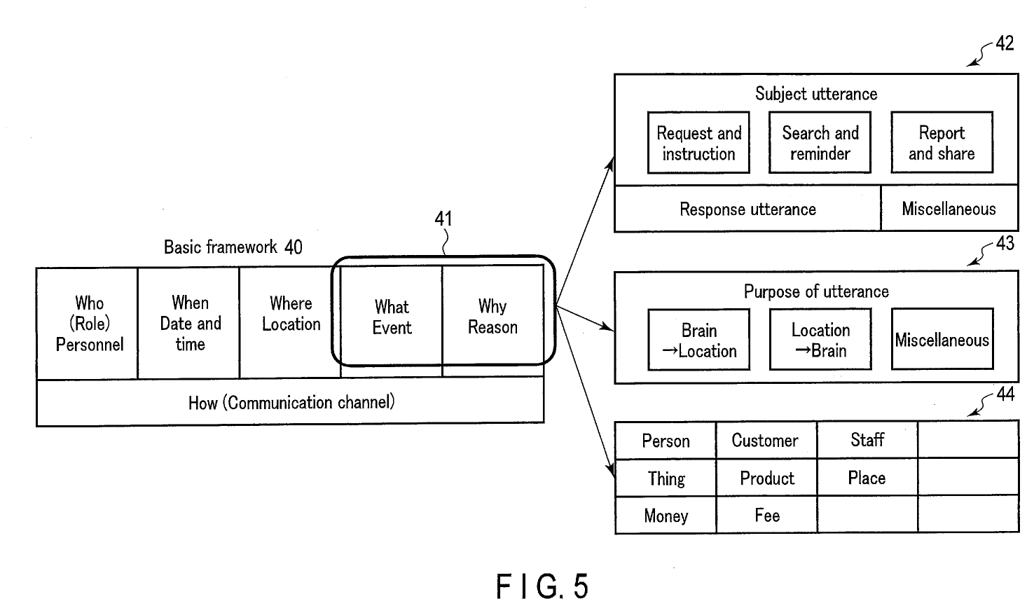

As shown in FIG. 4, the conversation analysis model processing section 21 processes conversational data collected by the information collecting section 20 based on the conversation analysis model trained by machine learning (S10). FIG. 5 is a conceptual diagram for illustrating the functions of the conversation analysis model processing section 21.

As shown in FIG. 5, the conversation analysis model processing section 21 processes conversational data using, for example, a conversation analysis model formed from the perspective of work cooperation and recognizing the degree of team cooperation in work execution. Specifically, the conversation analysis model processing section 21 classifies conversational data based on a basic framework 40 of the conversation analysis model.

The basic framework 40 consists of, for example, “person (Who: role)”, “date and time (When)”, “place (Where)”, “event (What)”, “reason (Why)”, and “conversation channel (How: communication channel)”. The “person (role)” refers to team members who carry out the type of work in cooperation with each other, such as team leaders (a manager, a landlady, etc.) and staff members (persons in charge of customer service, receptionists, etc.). The “communication channel” refers to a mutual call made by the headset call device 12 worn by each employee.

The conversation analysis model processing section 21 performs a behavior estimation process of the team members who carry out the type of work in cooperation with each other based on conversational data indicating the “event” and the “reason” included in the basic framework 40 (S11). As shown in FIG. 5, the conversation analysis model processing section 21 creates a plurality of classification models 42, 43, and 44 through a behavior estimation process (S12).

The classification model 42 is created as, for example, a behavior classification model that consists of five categories including three types: “subject utterance”; “response utterance”; and “miscellaneous”, with the subject utterance classified into “request and instruction”, “search and reminder”, and “report and share”. The classification model 43 is, for example, a spatial classification model that consists of three types. In the classification model 43, a “brain” refers to a person, and a “location” refers to a state. Furthermore, the classification model 44 is, for example, a work-by-work business element classification model.

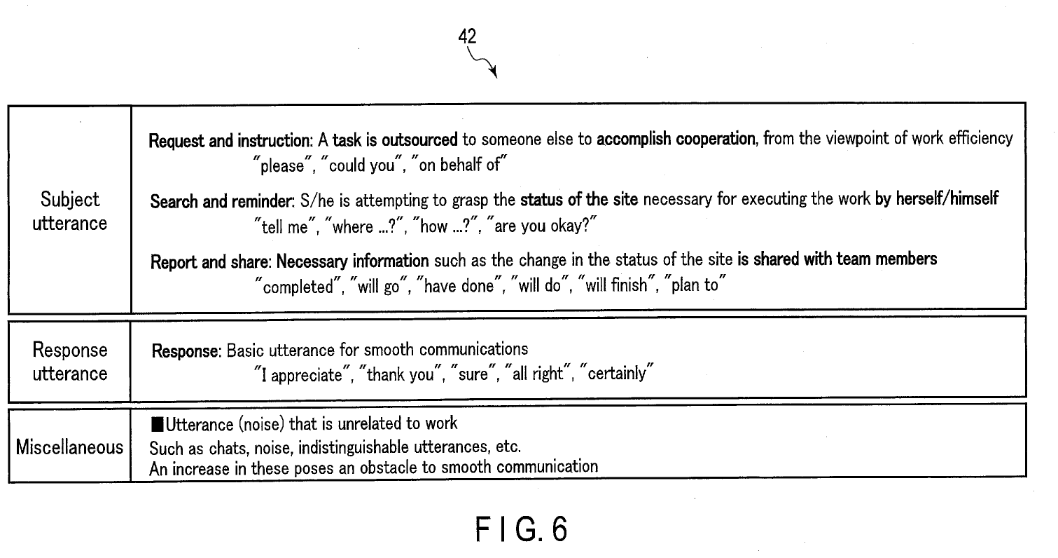

In the present embodiment, the conversation analysis model processing section 21 classifies the conversational data based on the classification model 42 (behavior classification model). FIG. 6 is a diagram showing an example of the classification model 42, which is a behavior classification model.

As shown in FIG. 6, the conversation analysis model processing section 21 adds classification labels “request and instruction”, “search and reminder”, and “report and share” to the contents of conversational data uttered by the team leaders and the staff members as the main utterer. Based on each classification label, the utterance can be identified as an utterance that refers to a subjective behavior as a requirement for work cooperation within the team.

As a specific example, the classification label “request and instruction” is added to utterances such as “please”, “could you”, and “on behalf of”. The utterance labeled “request and instruction” can be evaluated to signify that a task of work is outsourced to another person, resulting in accomplishment of work cooperation. The classification label “search and reminder” is added to utterances such as “tell me”, “where . . . ?”, “how . . . ?”, and “are you okay?” The utterance labeled “search and reminder” can be evaluated to signify that the status of the site necessary for executing the work can be grasped, resulting in accomplishment of work cooperation.

In addition, the classification label “report and share” is added to utterances such as “completed”, “will go”, “have done”, “will do”, “will finish”, “plan to”, etc. The utterance labeled “report and share” can be evaluated to signify that necessary information is shared with team members, resulting in accomplishment of work cooperation.

The conversation analysis model processing section 21 adds the classification label “response” to the contents of conversational data uttered by the team leaders or staff members as a response utterer. Based on the classification label “response”, the utterance can be identified as a basic utterance that indicates smooth communication in the team; a requirement for work cooperation in the team. The classification label “response” is added to utterances such as “I appreciate”, “thank you”, “sure”, “all right”, and “certainly”.

The conversation analysis model processing section 21 adds the classification label “miscellaneous” to an utterance (noise) of conversational data that is unrelated to work. The classification label “miscellaneous” is added to, for example, utterances (speeches) such as chats, noise, indistinguishable utterances, etc. The utterance labeled “miscellaneous” can be evaluated to signify that there is an obstacle to smooth communication in the team.

As shown in FIG. 3(B), analysis results obtained by the analysis conducted by the conversation analysis model processing section 21 are recorded in the data storage section 23, with an utterance type and a classification label added for each specific utterance content.

Referring back to the flowchart in FIG. 4, the conversation analysis model processing section 21 outputs a conversation analysis result relating to work cooperation among a plurality of utterers, based on the created predetermined classification model (S13).

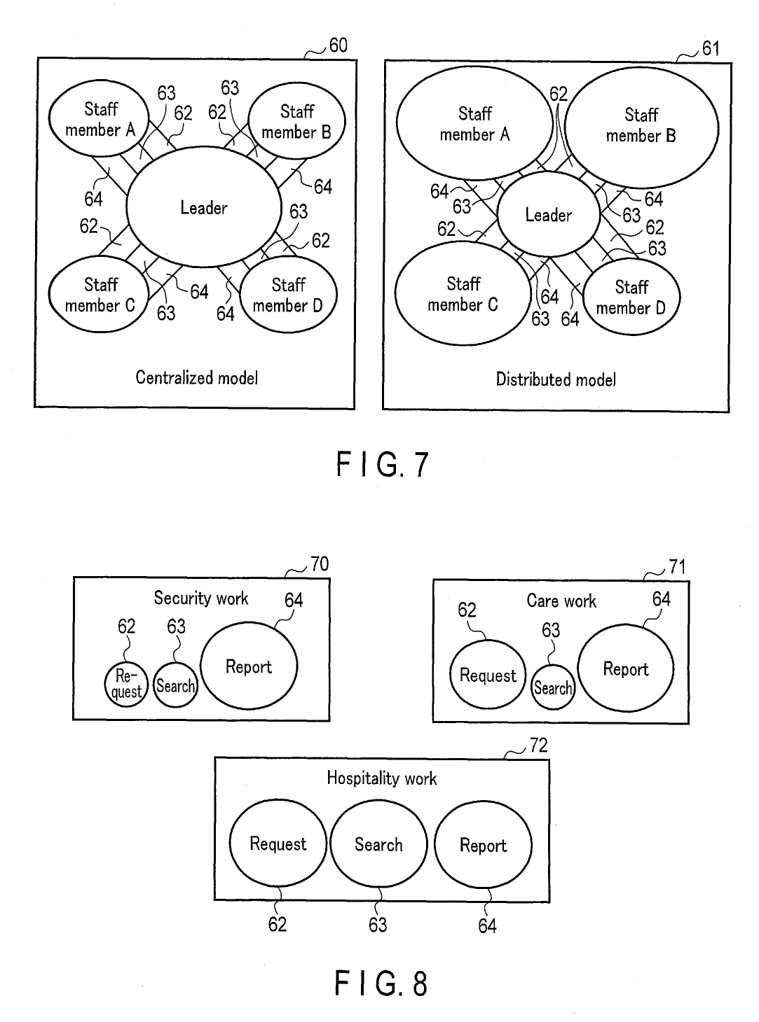

FIGS. 7 and 8 are conceptual diagrams showing an example of a conversation analysis result. As shown in FIG. 7, the conversation analysis result is information indicating, for example, a centralized model 60 or a distributed model 61 as a team cooperation model. As shown in FIG. 8, the conversation analysis result is, for example, information indicating a team cooperation model that has been classified by occupation.

The information indicating the team cooperation models shown in FIG. 7 shows analysis results based on the utterer ID, the number of utterances, and the classification label; and the size of the circle of each of a leader and staff members A to D corresponds to the number of utterances. Thick lines 62 to 64 which connect the leader and the staff members A to D respectively indicate the utterances “request”, “search”, and “report”. That is, in the centralized model 60, the number of utterances made by the leader is relatively large with respect to the number of utterances made by each of the staff members A to D. On the other hand, in the distributed model 61, the number of utterances tends to be dispersed, with the number of utterances of the staff members A, B, and C being relatively large, while the number of utterances of the leader not increasing significantly.

The information showing team cooperation models shown in FIG. 8 shows analysis results based on the classification labels and corresponds to the proportions of the numbers of utterances 62 to 64 labeled “request”, “search”, and “report” of each occupation. When, for example, the occupation is a security work 70, the number of utterances 64 labeled “report” constitutes a large proportion of the utterances made by the frontline security guard, compared to the number of utterances 62 and 63 labeled “request” and “search”.

Similarly, when, for example, the occupation is a form of care work 71, the number of utterances 64 labeled “report” constitutes a large proportion of the utterances made by the frontline caregiver. The number of utterances 62 labeled “request” also constitutes a relatively large proportion. On the other hand, when the occupation is a form of hospitality work 72, for example, the numbers of utterances 62 to 64 labeled “request”, “search”, and “report” constitute substantially the same proportion of the utterances made by the frontline staff member in charge of customer service.

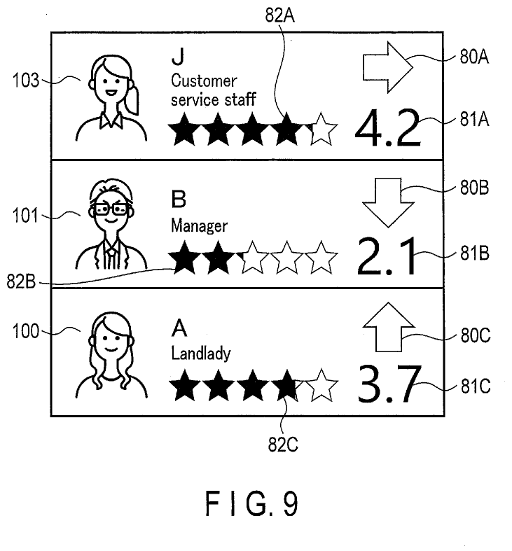

Next, specific examples of the dashboard created by the dashboard creating section 22 will be described with reference to FIGS. 9 to 17. As mentioned above, the dashboard creating section 22 creates a dashboard related to work cooperation among a plurality of utterers based on a conversation analysis result from the conversation analysis model processing section 21 recorded in the data storage section 23. The dashboard corresponds to a plurality of types of evaluation information related to work cooperation among a plurality of utterers.

In the present embodiment, a dashboard is created based on the assumption that a landlady (name A) 100, a manager (name B) 101, a receptionist 102, and a staff member 103 in charge of customer service are the utterers (employees) in a field of the hospitality industry such as a hotel. The dashboard creating section 22 creates a dashboard through the utilization of the conversation analysis result, the utterer ID, the number of utterances, and the speech recognition rate from the conversation analysis model processing section 21 recorded in the data storage section 23.

FIG. 9 is a diagram showing a first specific example of the dashboard. As shown in FIG. 9, the first specific example is, for example, a dashboard indicating the quality of utterances made by the utterers including a landlady (A) 100, a manager (B) 101, and a customer service staff member (name J) 103, as an element related to work cooperation. In this case, of the information recorded in the data storage section 23, the dashboard creating section 22 refers to information on targets of analysis: the landlady (A) with an utterer ID “100A”, the manager (B) with an utterer ID “100B”, and the customer service staff member (J) with an utterer ID “100D”, and creates a dashboard through the utilization of the conversation analysis result from the conversation analysis model processing section 21, and the information indicating the utterer ID, the number of utterances, and the speech recognition rate.

The dashboard items include, for example, the degree of growth over a long period (about one week to one month) indicated by arrows 80A, 80B, and 80C, and a speech recognition rate score represented by numerals 81A, 81B, 81C and the number of stars 82A, 82B, and 82C.

As for the degree of growth, a rightward-pointing arrow 80A indicates maintenance; furthermore, the display is shown in colors such as green when growth is favorable, and red or yellow when growth requires improvement. Similarly, a downward-pointing arrow 80B in red indicates deterioration. An upward-pointing arrow 80C in green indicates improvement. As for the speech recognition rate score, when the score is higher, the number of stars 82A is displayed in green, when the score is lower, the number of stars 82C is displayed in yellow, and when the score is the lowest, the number of stars 82B is displayed in red. A line graph including items for displaying a history showing the speech recognition rate score in chronological order may be plotted for each of the utterers.

By causing the output processing section 16 to display such a dashboard on a screen of a display device of a PC or a smartphone, the quality status of the utterances made by each utterer can be recognized based on the speech recognition rate score as an element related to work cooperation. Improvement in the quality of utterance contributes to smooth communications between the employees.

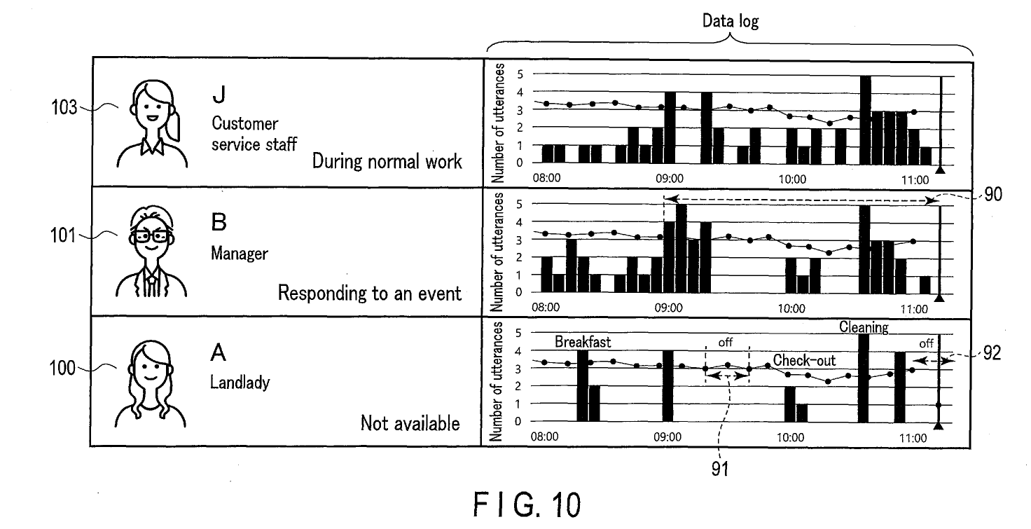

FIG. 10 is a diagram showing a second specific example of the dashboard. As shown in FIG. 10, the second specific example is, for example, a dashboard indicating the work status of each of the utterers such as a landlady (A) 100, a manager (B) 101, and a customer service staff member (name J) 103, as an element related to work cooperation. In this case, of the information recorded in the data storage section 23, the dashboard creating section 22 refers to the information on the utterer ID as a target of analysis, and creates a dashboard through the utilization of the conversation analysis result from the conversation analysis model processing section 21, and the information indicating the utterer ID, the number of utterances, the utterance timing, the position information, and the ON/OFF state of the headset call device 12.

As shown in FIG. 10, the work status shows the status of each employee, such as “calling”, “supporting event”, “not available”, etc. The work status can be grasped from the state of the headset call device 12 and the contents of conversations among the employees; however, the schedule information of employees other than the input information from the speech input processing unit 11 may also be used.

The dashboard includes not only the work status but also log information of data for each employee. In this log information, the horizontal axis represents time, and the vertical axis represents the number of utterances. Specifically, it indicates, for example, that the manager (B) 101 is supporting an event (90) held at the hotel from about 9:00 to 11:00 AM. Also, it indicates, for example, that the headset call device 12 of the landlady (A) 100 is turned off during times 91 and 92, during which the landlady (A) 100 is not available.

By causing the output processing section 16 to display such a dashboard on a screen of a display device of a PC or a smartphone of each employee, the individual status (busy, on a break, etc.) can be recognized. Thus, since the status of each employee can be shared as elements related to work cooperation, work cooperation among the employees can be smoothly achieved.

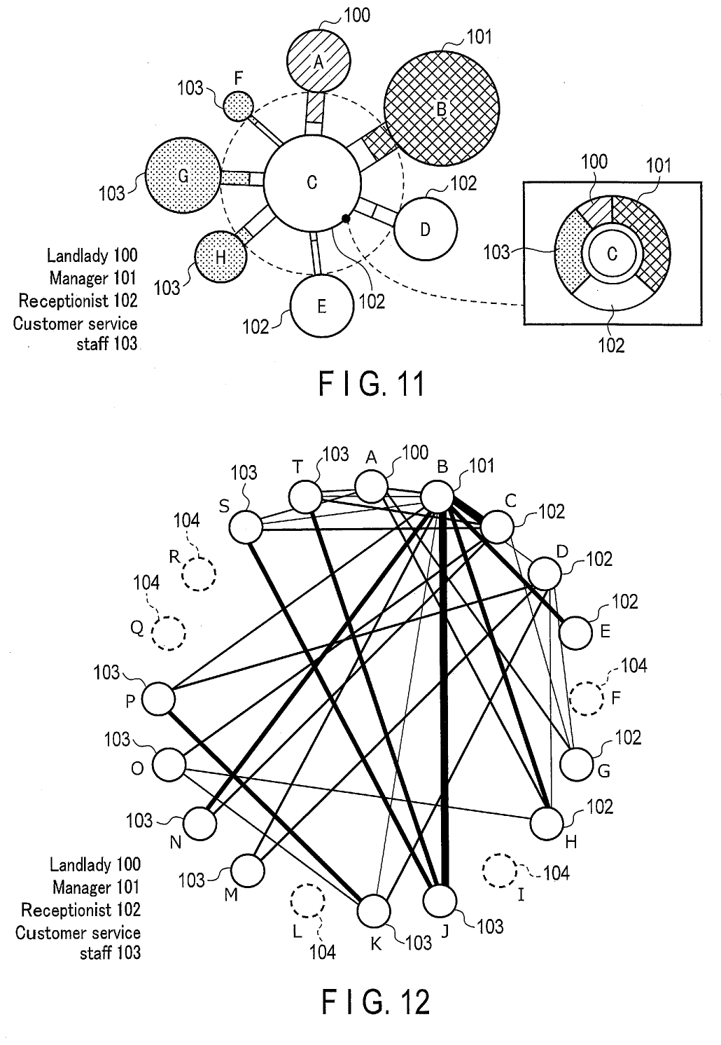

FIG. 11 is a diagram showing a third specific example of the dashboard. As shown in FIG. 11, the third specific example is a dashboard that indicates a communication status in the team, in particular, the communication status of each individual employee, as an element related to work cooperation.

The team consists of, for example, a landlady (A) 100, a manager (B) 101, receptionists (names C, D, and E) 102, and customer service staff members (names F, G, and H) 103. In this case, of the information recorded in the data storage section 23, the dashboard creating section 22 refers to information on the utterer ID as a target of analysis, and creates a dashboard through the utilization of the conversation analysis result from the conversation analysis model processing section 21, and the information indicating the utterer ID, the number of utterances, the utterance timing, and the utterance content.

As shown in FIG. 11, the area of a circle corresponding to each employee indicates the total amount of utterances (number of utterances/hour), and the display color indicates the occupation/role (e.g., manager). The thickness of each bar in the graph between the circles indicates the proportion of conversations with the other party to the total amount of utterances made by the two, and the ratio in the bar graph indicates the ratio of utterances between the two. In the case of the receptionist (C) 102, the amount of conversation with manager (B) 101 is larger than the amount of conversation with another receptionist (D) 102. In the case of conversations between the manager (B) 101 and the receptionist (C) 102, the utterance ratio of the manager (B) 101 is relatively high.

By clicking, for example, the circle of the receptionist (C) 102, the conversation ratio with the conversation partner can be displayed on a donut chart centered on that employee. Similarly, by clicking the circle of another employee, the display can be switched to a donut chart centered on that employee.

By causing the output processing section 16 to display such a dashboard on a screen of a display device of a PC or a smartphone of each employee, the individual status (busy, on a break, etc.) can be recognized. Thus, since the total amount of utterances of each employee and the ratio of utterances between the employees can be recognized as elements related to work cooperation, the degree of work cooperation among the employees, the tendency of correlation, and the like can be inferred.

FIG. 12 is a diagram showing a fourth specific example of the dashboard. As shown in FIG. 12, the fourth specific example is a dashboard that shows a communication status in the team as an element related to work cooperation. The team consists of, for example, a landlady (A) 100, a manager (B) 101, a receptionist 102, and a customer service staff member 103. The team also includes employees (F, I, L, Q, and R) 104, who are on holiday, for example, and whose headset call device 12 is turned off.

In this case, of the information recorded in the data storage section 23, the dashboard creating section 22 refers to the information on the utterer ID as a target of analysis, and creates a dashboard through the utilization of the conversation analysis result from the conversation analysis model processing section 21, and the information indicating the utterer ID, the number of utterances, the utterance timing, the utterance content, and the ON/OFF state of the headset call device 12.

As shown in FIG. 12, this specific example is a dashboard that visualizes the communication status in the team based on, for example, the tendency of the utterances of each employee on a given day. Here, each line connecting the employees indicates the other party of a mutual call, and the thickness of the line indicates the total amount of utterances (number of utterances per hour).

By causing the output processing section 16 to display such a dashboard on a screen of a display device of a PC or a smartphone of each employee, the communication status in the team can be recognized based on the total amount of utterances in the mutual call in the team. Thus, since it is possible to infer whether or not work cooperation centered on the manager (B) 101 has been realized as an element related to work cooperation, this can be used for improvement, etc. of the team management.

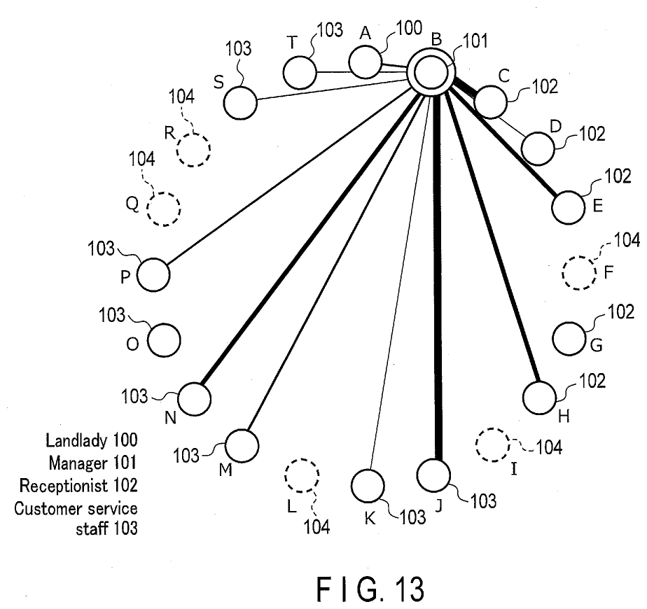

FIG. 13 is a diagram showing a fifth specific example of the dashboard. As shown in FIG. 13, the fifth specific example is a dashboard showing a communication status in the team as an element related to work cooperation, similarly to that shown in FIG. 12 described above. In this case, of the information recorded in the data storage section 23, the dashboard creating section 22 refers to the information on the utterer ID as a target of analysis, and creates a dashboard through the utilization of the conversation analysis result from the conversation analysis model processing section 21, and the information indicating the utterer ID, the number of utterances, the utterance timing, the utterance content, and the ON/OFF state of the headset call device 12.

As shown in FIG. 13, this specific example is a dashboard that visualizes the communication status in the team based on, for example, the tendency of the utterances made by a selected individual employee, such as a manager (B) 101. Here, each of the lines connecting to the manager (B) 101 indicates the other party of the mutual call, and the thickness of the line indicates the total amount of utterances (number of utterances per hour). Such lines may be made into a bar graph to express the proportion of utterances with the other party (see FIG. 11).

By causing the output processing section 16 to display such a dashboard on a screen of a display device of a PC or a smartphone of each employee, the communication status in the team can be recognized based on the total amount of utterances with the other party in the mutual call, focusing on each individual in the team. Thus, since the tendency of communications among the employees can be inferred as an element related to work cooperation, this can be utilized for improvement, etc. of the team operation. In addition, since the communication status can be displayed for each individual, as opposed to the simultaneous display of the communication statuses of all the members in the team as targets, as shown in FIG. 12, recognition of the communication status of each individual in the team is facilitated.

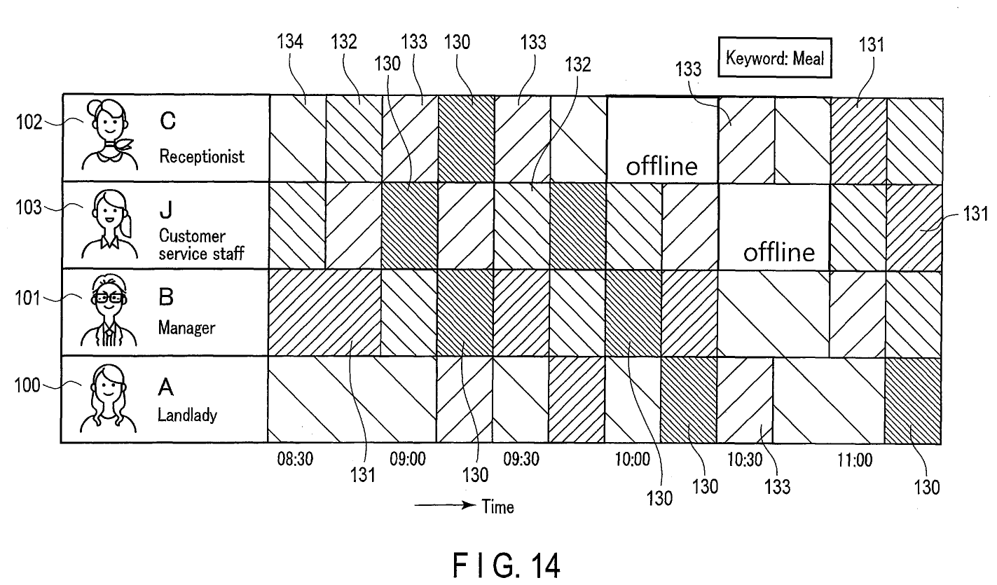

FIG. 14 is a diagram showing a sixth specific example of the dashboard. As shown in FIG. 14, the sixth specific example is a dashboard showing the status of utterances made by each employee in chronological order (timeline) as a communication status in the team, which is an element related to work cooperation. In this case, of the information recorded in the data storage section 23, the dashboard creating section 22 refers to the utterer ID as a target of analysis, and creates a dashboard through the utilization of the conversation analysis result from the conversation analysis model processing section 21, and the information indicating the utterer ID, the number of utterances, the utterance timing, the utterance content, the position information, and the ON/OFF state of the headset call device 12.

As shown in FIG. 14, this specific example is a dashboard that visualizes the communication status in the team based on, for example, the tendency of the utterances made by each employee on a given day in chronological order. Here, each of the slots 130 to 132 represents the numerical degree of the number of utterances. The slot 130 indicates that the number of utterances is relatively large, and the slots that follow indicate that the number of utterances is smaller. An “offline” area, which indicates that the headset call device 12 is OFF, indicates that the number of utterances is 0.

By causing the output processing section 16 to display such a dashboard on a screen of a display device of a PC or a smartphone of each employee, the communication status in the team can be recognized based on the number and timing of utterances made by each employee in the team. It can be recognized, for example, that the number of utterances made by both the landlady (A) 100 and the manager (B) 101 is relatively large during the period in which the receptionist (C) 102 is taking a break (offline area) (130). On the other hand, it can be recognized that the number of utterances made by both the landlady (A) 100 and the manager (B) 101 is very small during the period of time in which the customer service staff member (J) 103 is taking a break (offline area).

By recognizing such a communication status, the possibility that the work cannot be fully coped with in the absence of the receptionist (C) 102 can be realized, for example. It can be inferred from this either that the amount of work for the receptionist (C) 102 is excessive, or that the level of cooperation around such work is poor. The dashboard can thus be utilized for team organization and shift improvement, etc. as an element related to work cooperation. By allowing for selection of the contents to be displayed through input of a keyword (e.g., “meal”) as information contained in the utterances made by each employee, various work analysis can be conducted.

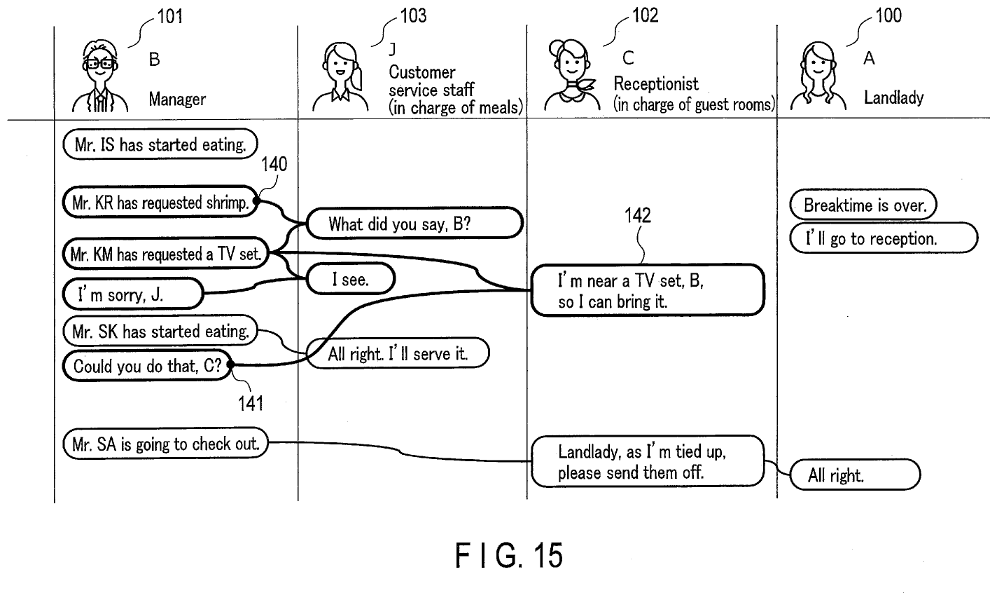

FIG. 15 is a diagram showing a seventh specific example of the dashboard. As shown in FIG. 15, the seventh specific example is a dashboard that shows the utterance content made by each employee in chronological order as a communication status in the team, which is an element related to work cooperation. In this case, of the information recorded in the data storage section 23, the dashboard creating section 22 refers to the utterer ID as a target of analysis, and creates a dashboard through the utilization of the conversation analysis result from the conversation analysis model processing section 21, and the information indicating the utterer ID, the number of utterances, the utterance timing, the utterance content, the position information, and the ON/OFF state of the headset call device 12.

As shown in FIG. 15, this specific example is a dashboard that visualizes the work status of each employee in the team based on, for example, the contents of utterances made by each employee on a given day in chronological order. Here, each slot and line indicate the connection of utterances made by each employee.

By causing the output processing section 16 to display such a dashboard on a screen of a display device of a PC or a smartphone of each employee, the work status and the cooperation state of each employee in the team can be recognized. It can be inferred, for example, from the customer service staff member (J) 103's response (“what did you say, B?”) to the utterance content 140 made by the manager (B) 101 that the meaning of utterance 140 is unclear. Alternatively, it can be inferred, for example, that the customer service staff member (J) 103 has misunderstood the content of an utterance made by the manager (B) 101 to be a meal-related matter. Furthermore, it can be inferred that, regarding the content 140 of the manager (B) 101's utterance, the work efficiency decreases as the number of utterances from the reply (142) of the receptionist (C) 102 to the reply (141) of the manager (B) 101 increases. In addition, it can be inferred that the work efficiency decreases as the time required from the start of the content 140 of the manager (B) 101's utterance to the reply (141) of the manager (B) 101 increases.

Therefore, since the work status and the cooperation state of each employee in the team can be recognized, it is possible to grasp and improve the work efficiency and communication problems in the team as elements related to work cooperation.

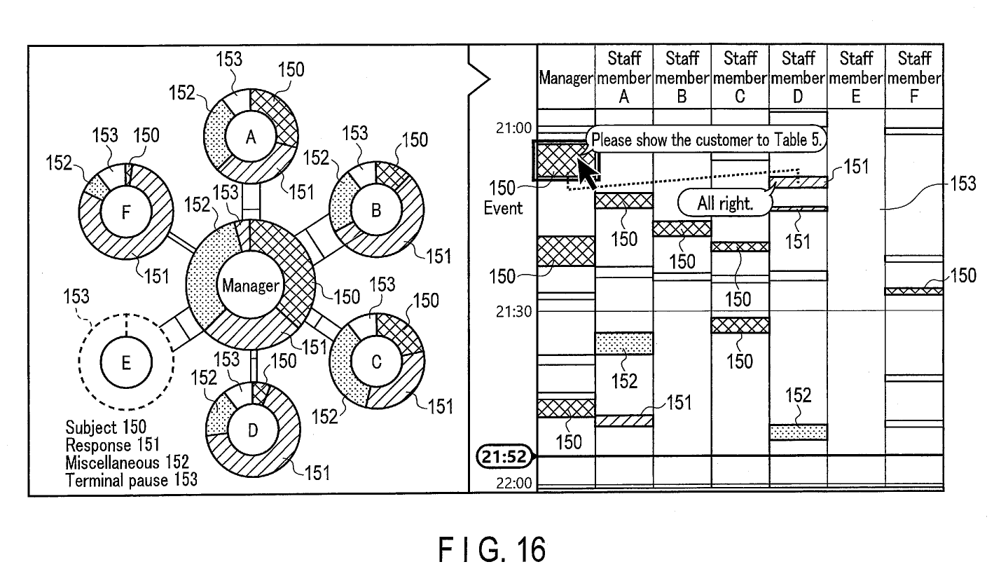

FIG. 16 is a diagram showing an eighth specific example of the dashboard. As shown in FIG. 16, the eighth specific example is a dashboard that shows the communication status in the team and the content of each employee's utterance in chronological order, which are elements related to work cooperation. In this case, of the information recorded in the data storage section 23, the dashboard creating section 22 refers to the utterer ID as a target of analysis, and creates a dashboard through the utilization of the conversation analysis result from the conversation analysis model processing section 21, and the information indicating the utterer ID, the number of utterances, the utterance timing, the utterance content, and the ON/OFF state of the headset call device 12.

As shown in FIG. 16, this specific example is a dashboard that visualizes the utterance type and the utterance timing of each employee in the team. Here, the donut chart centered on the manager 101 indicates, for example, the proportions of utterance types of each of the employees (the manager 101 and the staff members A to F) per day. The utterance type refers to “subject 150”, “response 151”, “miscellaneous 152”, and “terminal pause 153”. That is, the “subject 150” means that an instruction or a request has been uttered as the subject of communication in the team. The “response 151” means a response that has been made to the subject 150. The “miscellaneous 152” is, for example, a contact. The “terminal pause 153” indicates that the headset call device 12 is turned OFF and a call cannot be made. In this case, the staff member E is on vacation, etc., and cannot conduct a call with the manager 101.

The time chart showing the status of utterances made by each employee in chronological order shows, according to the utterance type, the duration of an utterance made by each employee at each time. For example, the manager 101 utters “Please show the customer at Table No. 5” as the subject 150 shortly after 21:00, and the staff member D replies “all right” as the response 151. Similarly, the status of utterances made by each employee is shown in chronological order according to the utterance type.

By causing the output processing section 16 to display such a dashboard on a screen of a display device of a PC or a smartphone of each employee, the communication status of each employee can be recognized according to the utterance type. From this recognition, it is possible to infer the team management ability of the manager serving as the leader and the status of the work cooperation of managers and staff members.

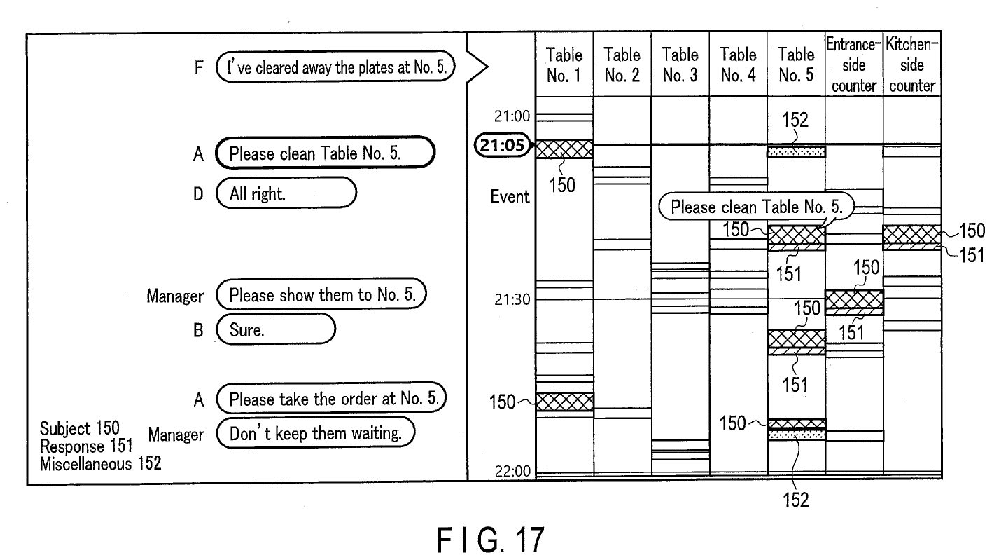

FIG. 17 is a diagram showing a ninth specific example of the dashboard. As shown in FIG. 17, the ninth specific example is, similarly to that of FIG. 16 described above, a dashboard that shows the communication status in the team and the contents of utterances made by each employee in chronological order, which are elements related to work cooperation. In this case, of the information recorded in the data storage section 23, the dashboard creating section 22 refers to the utterer ID as a target of analysis, and creates a dashboard through the utilization of the conversation analysis result from the conversation analysis model processing section 21, and the information indicating the utterer ID, the number of utterances, the utterance timing, and the utterance content.

As shown in FIG. 17, this specific example is a dashboard that visualizes the utterance contents made by each employee in the team per day, and the utterance timing at the workplace (site) in a complex manner. At Table No. 5, for example, the staff member A utters “Please clean Table No. 5” as the subject 150, and the staff member D replies “all right” as the response 151. Similarly, at the entrance side, for example, the manager utters “Please show them to No. 5” as the subject 150, and the staff member B replies “sure” as the response 151.

By causing the output processing section 16 to display such a dashboard on a screen of a display device of a PC or a smartphone of each employee, the communication status of each employee can be recognized according to the utterance type. From this recognition, it is possible to infer both the team management ability of the manager serving as the leader and the status of the work cooperation of managers and staff members.

As described above, by constructing the conversation analysis system of the present embodiment on a client-side PC, for example, as a system for supporting the operation of locations in the food industry or accommodation facilities (hotels), conversations between the employees engaged in work at certain locations in the food industry, accommodation facilities, etc. can be analyzed. The conversation analysis system of the present embodiment can be realized by an information processing function provided as a service by the cloud server system 17.

The conversation analysis system of the present embodiment outputs a conversation analysis result through conversation analysis processing between the employees, and creates, based on the conversation analysis result, a dashboard of the status of communications between the employees related to work cooperation in various display formats. Accordingly, by displaying such a dashboard on a screen of a smartphone or a PC, etc., the communication status between the employees can be visualized in various display formats. Thus, it is possible to infer, at a certain location in the food industry, an accommodation facility (hotel), etc., the smoothness of communications between the employees, the work cooperation status, the work efficiency of the employees, etc.

It is thereby possible to compare, based on the dashboard, the productivity obtained by work cooperation among the employees from the causal relationship (correlation) with the sales amount for each location, for example, thus resulting in additional support for the planning of analysis, measures, and management guidance, etc. for improving operational status and productivity. In the comparison and analysis processing of the productivity, conversation analysis data, etc. for each field, industry, and work may be used, similarly to the target of analysis.

(Modifications)

In the above-described embodiment, specific examples of creation of the dashboard for (visualization of) the analysis result in the conversation analysis system have been described, such as visualization of the quality of utterance of each utterer (FIG. 9), visualization of the work status of each utterer (FIG. 10), the amount of utterances of each utterer and the proportions of conversations among the utterers (between the two) (FIG. 11), the communication status in the team, such as the other party in the mutual call and the amount of conversation with the other party (FIGS. 12 and 13), a chronological display of the communication status in the team (FIGS. 14, 15 and 16), and the like; however, in the present modification, an example of visualizing the communication status in the team from an utterance content perspective by categorizing and displaying the analysis results of the contents of utterances, focusing on the contents of utterances, will be described.

The configuration and operation flow of the conversation analysis system for visualization are the same as the configuration and the operation flow described in the embodiment; however, the processing of classifying conversations and creating a dashboard (visualization) for dashboard creation are different. In this modification, the analysis result from the contents of conversations is visualized through the utilization of a classification label set by the conversational data classification process based on a behavior classification model 42.

Specifically, in the conversation analysis processing of the present modification, the conversation analysis model processing section 21 performs, based on the behavior classification model 42, a process of further classifying conversations to which the utterance type (subject utterance, response utterance, and miscellaneous) and the classification label (“request and instruction”, “search and reminder”, and “report and share”) are attached into the following areas shown below.

(1) A “basic quality area”, into which primary conversations (work instructions, completion reports, etc.) within the team during normal work are classified, is included in utterances to which the type of the subject utterance and the type of the response utterance are added.

(2) A “value creation area”, into which conversations (complaint information sharing, job support, etc.) that would improve the team ability are classified, is mainly included in subject utterances to which the classification labels “search and reminder” and “report and share” are added.

(3) An “out-of-mission area”, into which conversations (chats, inefficient operations, etc.) that could lead to reduction of waste and improvement of operations are classified, is mainly included in utterances to which the type “miscellaneous” is attached.

(4) A “noise area”, into which undesired sound and indistinguishable noise are classified, is mainly included in an utterance to which the type “miscellaneous” is added.

Next, the classification process for each of the areas in the conversation analysis model processing section 21 will be described in detail.

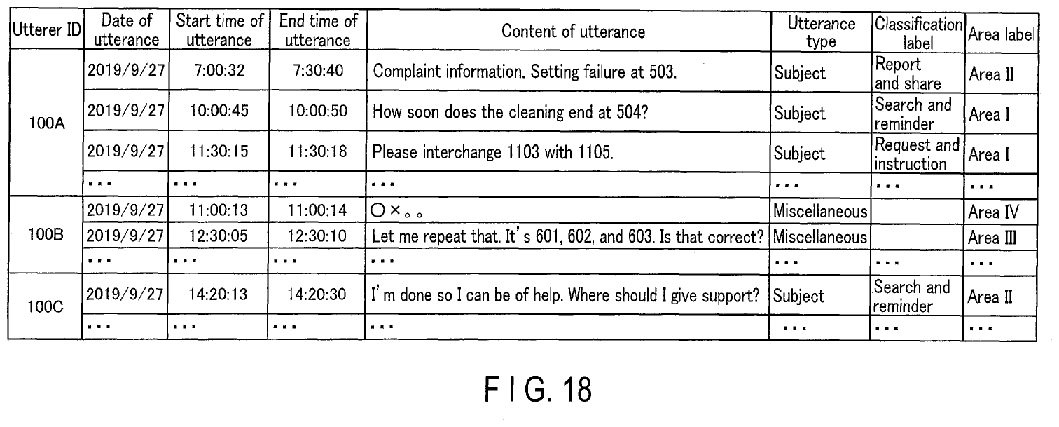

FIG. 18 is a diagram showing an example of incidental information of conversational data output to the conversation analysis model processing section 21 in the present modification. These items of information are stored in, for example, the data storage section 23.

As shown in FIG. 18, regarding the utterance information input from the headset call device 12, the conversation analysis model processing section 21 records an utterer ID, an utterance date, an utterance start time, an utterance end time, an utterance content, an utterance type attached based on a behavior classification model of the analysis model 42 shown in FIG. 6, and a classification model in association with each other, as in the above-described embodiment. Moreover, the conversation analysis model processing section 21 sets a “basic quality area (Area I label)” to conversations whose utterance type is “subject” and to which the “request and instruction” is attached, and utterances to which the utterance type “response” is attached. Of the utterances whose utterance type is “subject” and to which the “search and reminder” or the “report and share” are attached, the “basic quality area (Area I label)” is set in conversations corresponding to reminders and reports in reply to work requests and instructions, such as “how soon does it end?” and “completed”.

On the other hand, of the utterances whose utterance type is “subject” and to which the “search and reminder” or the “report and share” is attached, a “value creation area (Area II label)” is set in utterances for improving the team ability such as information to be shared and addressed within the team, other than reminders and reports, in reply to work requests and instructions, such as “received a complaint”, “complaint information” as well as concerns within the team such as “I will help” and “I will support the job”.

Of the conversations with the conversation type “miscellaneous”, an “out-of-mission area (Area III label)” is set to utterances regarding chats other than undesired sound and noise and inefficient operations such as “let me repeat”. Of the utterances with the conversation type “miscellaneous”, a “noise area (Area IV label)” is set for undesired sound and noise.

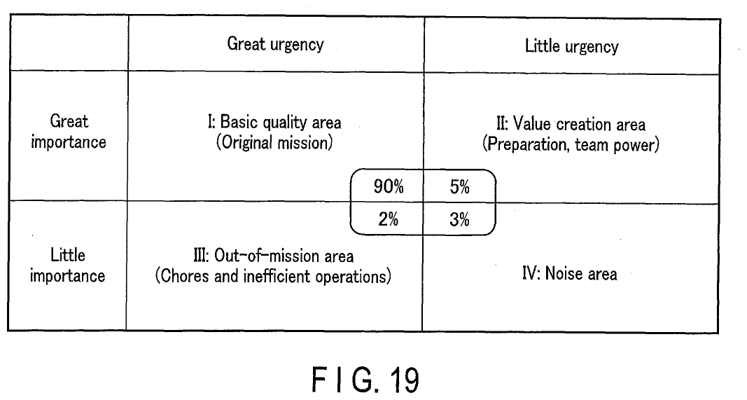

Next, a dashboard showing an analysis result of conversations based on an area label set in the conversation analysis model processing section 21 will be described. FIG. 19 is a diagram for illustrating a specific example of a dashboard according to the modification.

The dashboard creating section 22 expresses, based on the area label set in a predetermined range of conversations in the team by the conversation analysis model processing section 21, conversations in the team according to the proportion of utterances corresponding to each area, as shown in FIG. 19. By thus providing a matrix display, the communication status in the team can be recognized without individually referring to the conversation history in the team. For example, in the case of chain locations in the food industry and accommodation facilities (hotels), etc., it is possible to analyze communication issues in the team by comparing such a matrix display of each location or facility.

While certain embodiments have been described, these embodiments have been presented by way of examples only, and are not intended to limit the scope of the invention. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A conversation analysis system, comprising:
a memory; and
a processor connected to the memory and that:
inputs conversational data of utterers who carry out a type of work in cooperation;
analyzes contents of conversations related to work cooperation made by a plurality of utterers based on the conversational data input, using a conversation analysis model created by machine learning; and
creates a plurality of types of evaluation information related to work cooperation based on a conversation analysis result obtained.

2. The conversation analysis system according to claim 1, wherein the conversation analysis system is configured utilizing an information processing function provided as a service by cloud computing.

3. The conversation analysis system according to claim 1, wherein
the processor, to input conversational data of utterers who carry out a type of work in cooperation, collects speech data of a plurality of utterers and generates conversational data indicating a conversation content related to work cooperation.

4. The conversation analysis system according to claim 3, wherein
the processor, to input conversational data of utterers who carry out a type of work in cooperation, collects speech data based on a speech recognition result of a plurality of utterers using a wireless mutual communication means.

5. The conversation analysis system according to claim 1, wherein
the processor, to analyze contents of conversations related to work cooperation made by a plurality of utterers based on the conversational data input, using a conversation analysis model created by machine learning:
classifies conversational data of utterers from a viewpoint of work cooperation; and
outputs a conversation analysis result related to work cooperation among the utterers using the classified conversational data.

6. The conversation analysis system according to claim 5, wherein
the processor, to analyze contents of conversations related to work cooperation made by a plurality of utterers based on the conversational data input, using a conversation analysis model created by machine learning:
classifies conversational data of an utterer into utterance types including a subject utterance and a response utterance through a behavior estimation process; and
outputs conversation analysis result related to work cooperation among utterers using the classified conversational data.

7. The conversation analysis system according to claim 1, wherein
the processor, to create a plurality of types of evaluation information related to work cooperation based on a conversation analysis result obtained, creates a dashboard related to work cooperation among a plurality of utterers based on a result of the conversation analysis.

8. The conversation analysis system according to claim 7, wherein
the processor, to create a plurality of types of evaluation information related to work cooperation based on a conversation analysis result obtained, creates a dashboard indicating a status of communications among a plurality of utterers by utilizing a result of the conversation analysis, and information indicating the number and contents of utterances of each utterer.

9. A method to be applied to a conversation analysis system that utilizes a computer, comprising:
a process of inputting conversational data of utterers carry out a type of work in cooperation;
a process of analyzing contents of conversations related to work cooperation made by a plurality of utterers based on input conversational data, using a conversation analysis model created by machine learning; and
a process of creating a plurality of types of evaluation information related to work cooperation based on a conversation analysis result.

10. A program for causing a computer to execute the processes according to the method of claim 9.
